(19) United States
(12) Patent Application Publication
(10) Pub. No.: US 2004/0143511 A1
(43) Pub. Date: Jul. 22, 2004

(54) Method and apparatus for web-based configuration of instrumentation, and business methods employing same

(75) Inventors: Michael J. Miller, Poughkeepsie, NY (US); Stephen Tomasiewicz, Newton, CT (US); Steven J. Lacker, Blauvelt, NY (US); Chris Wichman, Poughkeepsie, NY (US)

Correspondence Address: HARRINGTON & SMITH, LLP, 4 RESEARCH DRIVE, SHELTON, CT, 06484-6212, US

(73) Assignee: Curtis Instruments, Inc.

(21) Appl. No.: 10/678,654

(22) Filed: Oct. 2, 2003

Related U.S. Application Data
(60) Provisional application No. 60/436,770, filed on Dec. 26, 2002.

(51) Int. Cl. G06F 17/60

(52) U.S. Cl. 705/26

(57) ABSTRACT

A method and a system are disclosed to at least specify, document and prototype a device, such as a gauge, having specific user interface elements to meet individual customer/market needs. The method includes displaying, with a graphical user interface, an image of a customer-selected gauge type; enabling the customer to specify, with the graphical user interface, individual ones of a plurality of gauge parameters in a self-documenting fashion; in response to a selection of at least one type of gauge parameter, updating the displayed image to correspond to the selected gauge parameter; and developing at least one prototype gauge for the customer based on the selected gauge parameters and the self-documentation. In the preferred embodiment the method also includes manufacturing gauges based on the selected gauge parameters and the self-documentation. This invention further provides a method to specify a gauge including displaying, at a web site, an image of a selected gauge type, specifying individual ones of gauge functions using a plurality of drop down menus and, in response to a selection of at least one type of gauge function, changing the displayed image to correspond to the selected gauge function.

### CLAIM OF PRIORITY FROM COPENDING PROVISIONAL PATENT APPLICATION

This patent application claims priority under 35 U.S.C. §119(e) from Provisional Patent Application No. 60/436,770, filed Dec. 26, 2002, the disclosure of which is incorporated by reference herein in its entirety.

### TECHNICAL FIELD

These teachings relate generally to instruments, such as gauges and indicators, and to techniques for a user, also referred to herein as a customer or a potential customer, to specify a desired instrument configuration and to quickly obtain samples thereof. These teachings also relate to techniques for configuring an instrument in accordance with the specified needs of a customer or a potential customer. These teachings further relate to methods for conducting business using a data communications network, such as one that includes a World Wide Web (Web) site that supports a graphical user interface (GUI) for enabling a customer or a potential customer to view and specify an instrument, such as a gauge or an indicator, and to process the customer's request through various groups and entities within an organization so as to provide a sample instrument for the customer. These teachings further provide a self-documenting process that allows a customer-approved sample to rapidly become a manufactured product.

### BACKGROUND

A conventional approach for a customer to specify an instrument, such as a gauge, involves examining a catalog or other sales literature, and selecting a combination of offered features that best suit the needs of the customer. An order may then be created whereby the customer is eventually provided with one or more sample gauges based on the previously selected features. If the sample meets the customer's expectations, then an order may be made for some production number of gauges.

As can be appreciated, should the sample gauge(s) not meet the customer's expectations for whatever reason, it may be necessary to re-specify the gauge, and then wait for new samples to arrive. This procedure can be time consuming, inefficient and costly with regard to both personnel and materials.

In accordance with conventional practice, a specific customer request would require a specific hardware/software solution that involved a long design/development cycle. Customer specifications had to be defined, and then prototypes had to be designed, tested, and brought into production. This is a time consuming and expensive process that involves contributions from Marketing, Sales, Engineering and Manufacturing in order to realize the new product.

### SUMMARY OF THE PREFERRED EMBODIMENTS

The foregoing and other problems are overcome, and other advantages are realized, in accordance with the presently preferred embodiments of this invention.

In one aspect this invention provides a method and a system to at least specify, document and prototype an instrument, such as a gauge, so as to have specific user interface elements to meet individual customer/market needs. In a presently preferred embodiment the method includes displaying, using a graphical user interface, an image of a customer-selected gauge type; enabling the customer to specify, with the graphical user interface, individual ones of a plurality of gauge parameters in a self-documenting fashion; in response to a selection of at least one type of gauge parameter, updating the displayed image to correspond to the selected gauge parameter; and developing at least one prototype gauge for the customer based on the selected gauge parameters and the self-documentation. In the preferred embodiment the method also includes manufacturing gauges based on the selected gauge parameters and the self-documentation.

In another aspect this invention provides a method to specify a gauge. The method includes displaying, at a web site, an image of a selected gauge type; specifying individual ones of gauge functions using a plurality of drop down menus and, in response to a selection of at least one type of gauge function, changing the displayed image to correspond to the selected gauge function. The method further includes preparing at least one sample of the selected gauge type in accordance with the selected gauge functions.

In a further aspect this invention provides a method to enable a user of a tool, such as a web tool, to specify a gauge. This method includes displaying an image of a selected gauge type while displaying, in association with the selected gauge type, a set of visual aids, referred to herein as icons and advisories, corresponding to configurable gauge parameters, also referred to as functions; enabling the user to specify individual ones of the configurable gauge functions using the set of visual aids with a drag and drop technique for selecting individual visual aids from the set of visual aids and associating a selected visual aid with a configurable gauge function. The method further includes outputting a data file for use in preparing at least one sample of the selected gauge type in accordance with the gauge functions corresponding to the selected visual aids. In one embodiment the configurable gauge functions are located at fixed locations in the image, while in another embodiment the configurable gauge functions are located at user selected locations in the image. The configurable gauge functions may have a fixed size and shape, or they may have at least one of a size and a shape that is selected by the user.

Also disclosed are web tools that operate in accordance with the methods, as well as methods of conducting business over a data communications network, such as the Internet, that employ the disclosed tools.

An aspect of this invention provides a quick time-to-market that enables rapid specification/sample rendering, while providing a self-documenting process that allows an approved sample to be quickly implemented as a manufactured product. The steps involved in configuring an instrumentation product include: specifying, documenting, prototyping and manufacturing specific user interface elements to meet individual customer/market needs.

In accordance with aspects of this invention platform-based products are designed to allow basic sets of hardware to serve multiple market needs, and user interface elements of platform-based instrumentation products are enabled to be configured in a straightforward manner. The invention provides a significantly reduced time-to-market cycle based on a product that is designed to provide a plurality of user interface functions. A computer program resident in the product is designed to accept parameters from a Configurator Program that is resident in an external PC or on a WEB site. The customer (or an OEM) uses the Configurator Program to define the exact user interface elements that are desired in the end product. An output of the Configurator Program is a parameter table that is downloaded to the product. The product firmware uses the downloaded parameter table to enable the user interface functions that were defined by the Configurator Program. The Configurator Program can also be used to define overlay elements. The combination of the Configurator Program with platform-based products greatly shortens the development time required to meet specific market/customer needs.

In a further aspect there is provided an instrument that includes a display for showing at least one user interface element and an instrument controller that is coupled to a memory, to the display and to at least one instrument input. The memory stores data for use by the instrument controller in mapping between the at least one instrument input and the at least one user interface element. The data includes data developed during an interactive design process where there was displayed an image of a selected instrument type for enabling a potential customer to specify, through the use of a graphical user interface, at least one characteristic of the at least one user interface element. In the preferred embodiment the data developed during the interactive design process is suitable for use in obtaining at least one prototype sample of the instrument having the specified at least one characteristic of the at least one user interface element. In the preferred embodiment the at least one user interface element comprises a gauge function.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIGS. 1A-1C, collectively referred to as FIG. 1, show a display screen that depicts, at different points in a specification procedure, a gauge and a plurality of drop down boxes, in accordance with a first web tool embodiment of this invention, whereby a customer is enabled to specify various aspects of the gauge;

FIGS. 2A-2D, collectively referred to as FIG. 2, show a display screen that depicts, at different points in a specification procedure and in accordance with a second web tool embodiment of this invention, a gauge and a plurality of visual aids corresponding to various gauge functions, whereby a customer is enabled to specify various aspects of the gauge using a drag-and-drop procedure;

FIGS. 3A-3C, collectively referred to as FIG. 3, show a display screen that depicts, at different points in a specification procedure and in accordance with a third web tool embodiment of this invention, a blank gauge face and the plurality of visual aids, whereby a customer is enabled to specify various aspects of the gauge, including the locations and optionally the sizes and shapes of the various functional indicators using a drag-and-drop procedure and an optional drawing tool;

FIG. 4 is a logic flow diagram showing a sample fulfillment process for a standard gauge model, beginning with the web tool in accordance with any one of FIGS. 1-3; and

FIG. 5 is a logic flow diagram showing a sample fulfillment process for a non-standard (custom) gauge, beginning with the web tool in accordance with any one of FIGS. 2 and 3.

### DETAILED DESCRIPTION OF THE PREFERRED EMBODIMENTS

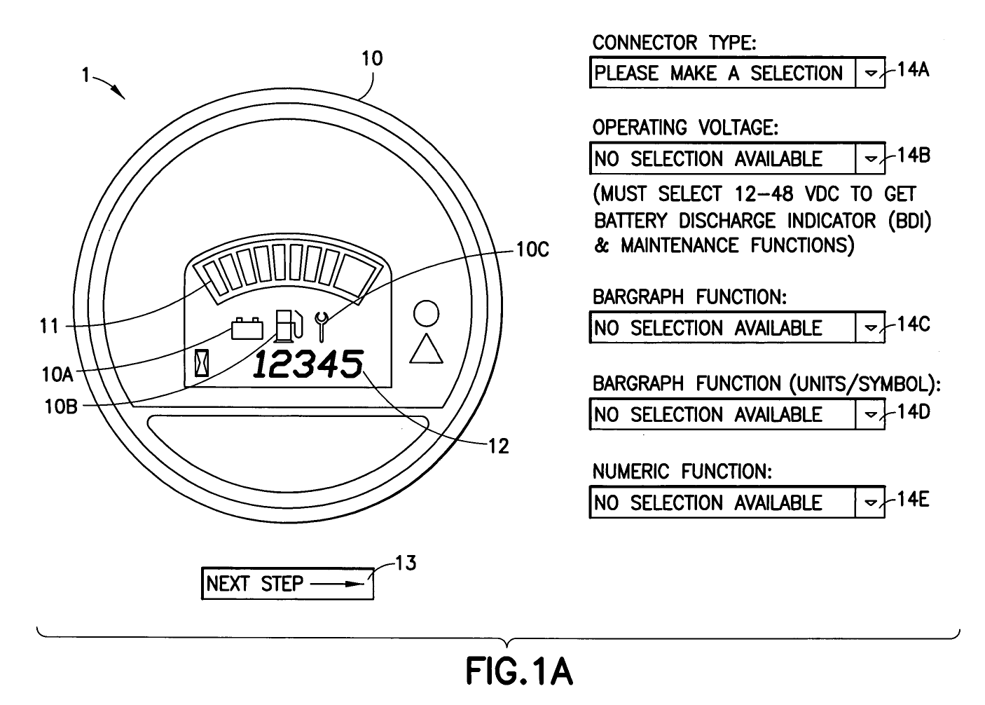

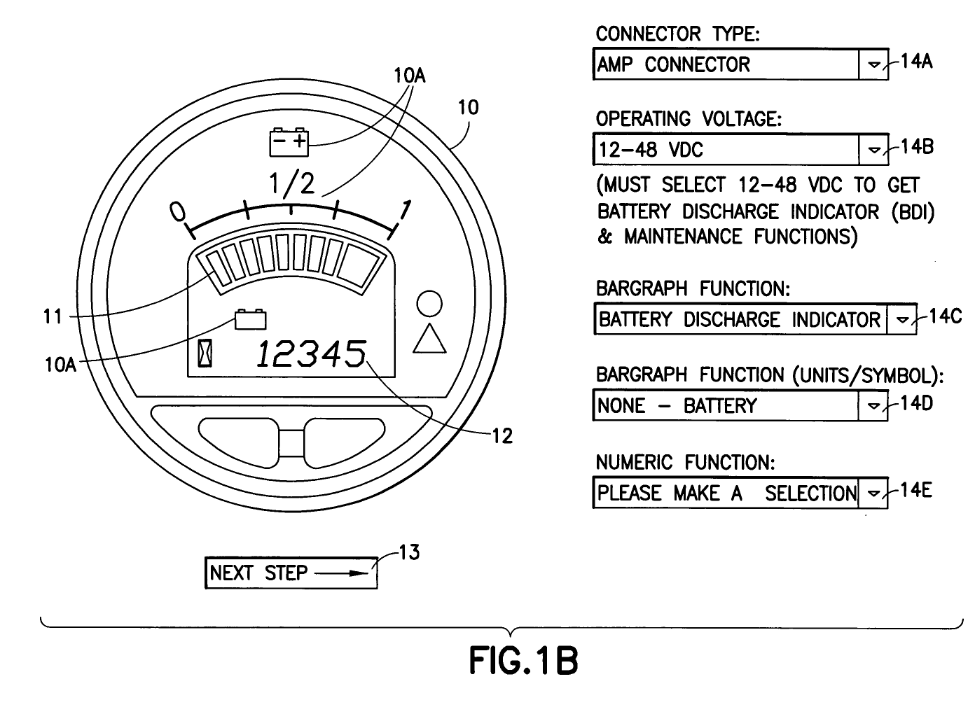

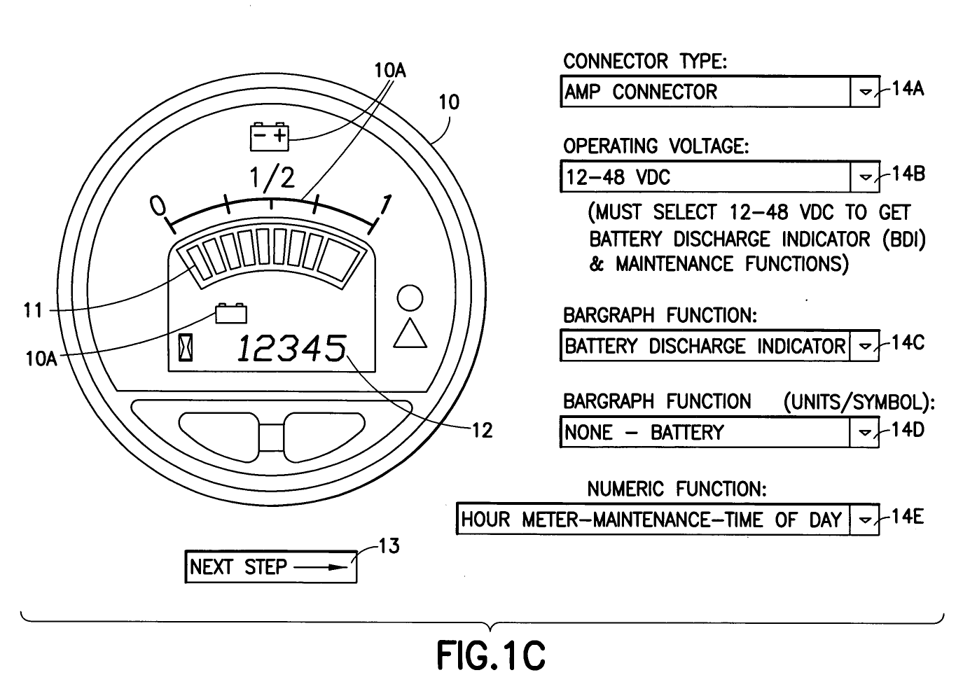

In general, FIGS. 1, 2 and 3 illustrate embodiments of an instrument design and/or specification tool, also referred to as a Configurator Program, that can be resident in a computer, such as a personal computer (PC) or a computer that is located at, or that otherwise serves, a site reachable through a data communications network, such as a Web site reached through the Internet.

FIG. 1A is an exemplary display screen 1 showing, in accordance with a first web tool embodiment of this invention, a gauge 10 and a plurality of drop down menus or boxes 14A-14E, whereby a customer is enabled to specify various aspects of the gauge. In this embodiment the customer or potential customer enters the web site of the gauge manufacturer or distributor, selects the gauge of most interest from a list or menu of available customer-configurable gauges, and then is presented with the image shown in FIG. 1A. Each drop down box 14 offers the customer the ability to select from at least one, and in most cases several, configuration choices. For example, in drop down box 14A the customer selects a desired type of electrical connector for the gauge, and in drop down box 14B the customer selects a desired gauge operating voltage (e.g., 6V or 12V-48V). Drop down boxes 14C-14E pertain most directly to the presentation of the gauge 10 itself. For example, as shown in FIG. 1A the gauge face displays a plurality of visual aids, such as icons and/or advisories 10A (battery discharge indicator), 10B (fuel level), 10C (maintenance) beneath the bar graph indicator 11. By selecting, for example, the battery discharge indicator in drop down box 14C the fuel level and maintenance visual aids 10B and 10C disappear from the image of the gauge 10, leaving only the battery discharge indicator 10A as shown in FIG. 1B. Note as well the automatic modification made above the bar graph indicator 11 to correspond to the selected battery discharge indicator 10A. When the drop down box 14D is selected the units/symbol are defaulted to those appropriate for the selected battery discharge function (or none in this case). FIG. 1C shows the selection of the numeric function corresponding to the numeric indicator 12.

Note that as discussed herein a visual aid is intended to encompass icons used as symbols to depict a condition, as well as to encompass advisories, that are similar to icons but that are instead expressed as text. It should be noted that scales and units may also be configurable, and may thus generally be included under the category of visual aids.

In the manner disclosed with respect to FIG. 1 the customer is presented with an image of the gauge 10 that corresponds to his or her selections, and the image is updated in real-time as the customer makes new selections, or changes a previous selection. This process thus greatly aids the customer in specifying and visualizing the finished gauge, and aids in envisioning the final form of the physical gauge.

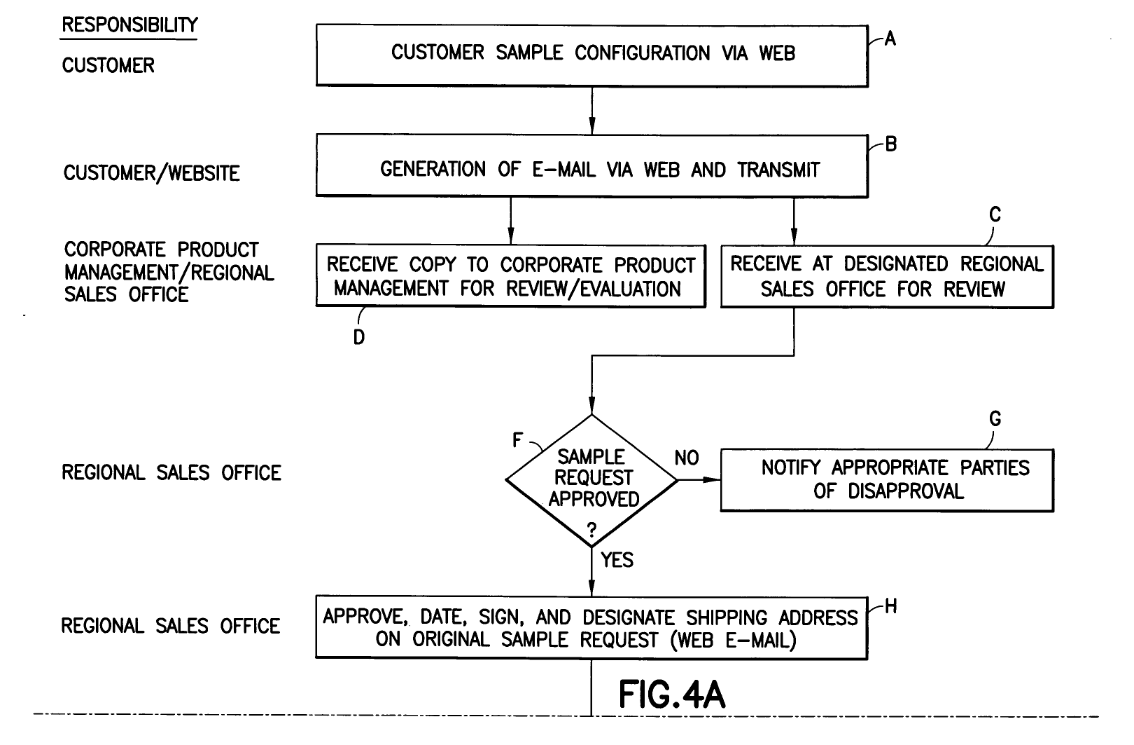

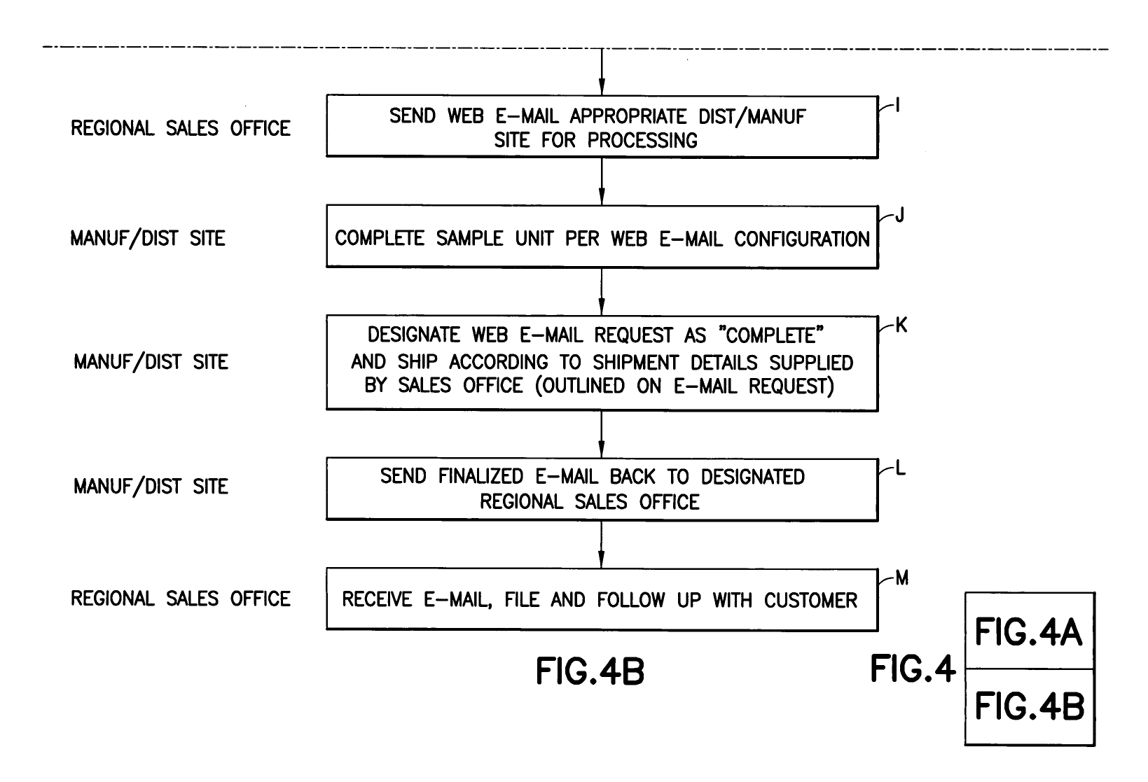

When the specification process is completed the customer selects the Next Step button 13, which then displays a screen where the customer is presented with a form where the customer fills in certain information required by the manufacturer in order to generate a sample or samples of the specified gauge 10. Upon completing the form, the form is automatically sent by email, along with a data file or data object representing the customer's drop down menu selections, to a sales office or similar group who verify the authenticity of the sample request. These activities correspond to the blocks A, B, C and F of FIG. 4. Note that from block B the customer's request can also be routed in parallel to a corporate product management group for review and evaluation (block D). At block F the sales office either approves or rejects the sample request. If rejected flow passes to block G to notify the customer that the sample request was not approved, otherwise flow passes to block H and thence to blocks I through M to generate the desired sample(s) and return same to the customer, possibly via the sales office. Note that blocks H-M involve not only the sales office, such as a regional sales office near to the customer, but also a manufacturer/distributor site. In the preferred embodiment the sample is made available to the customer within some number of days, such as three days, of the initial order.

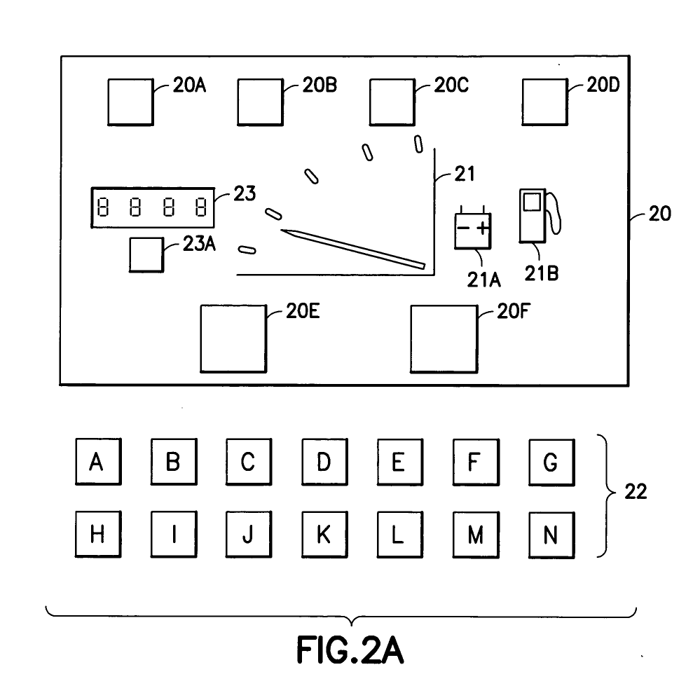

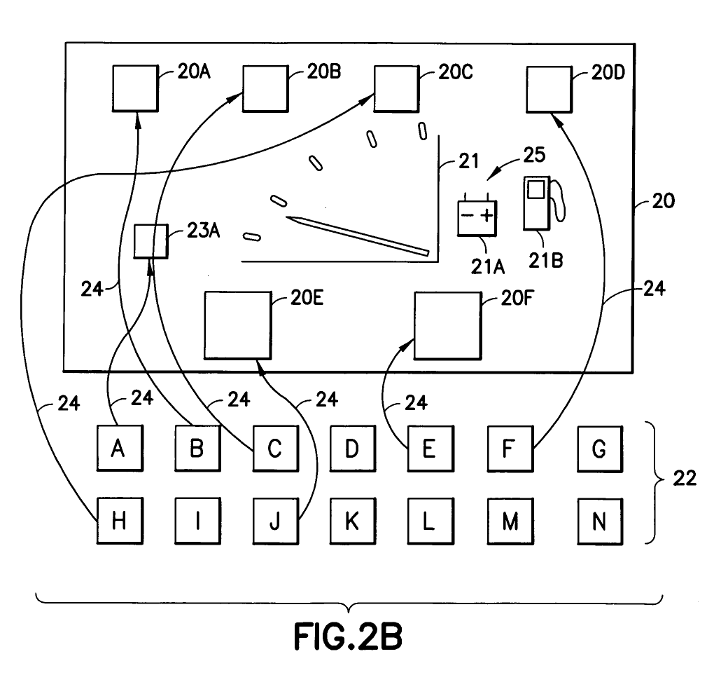

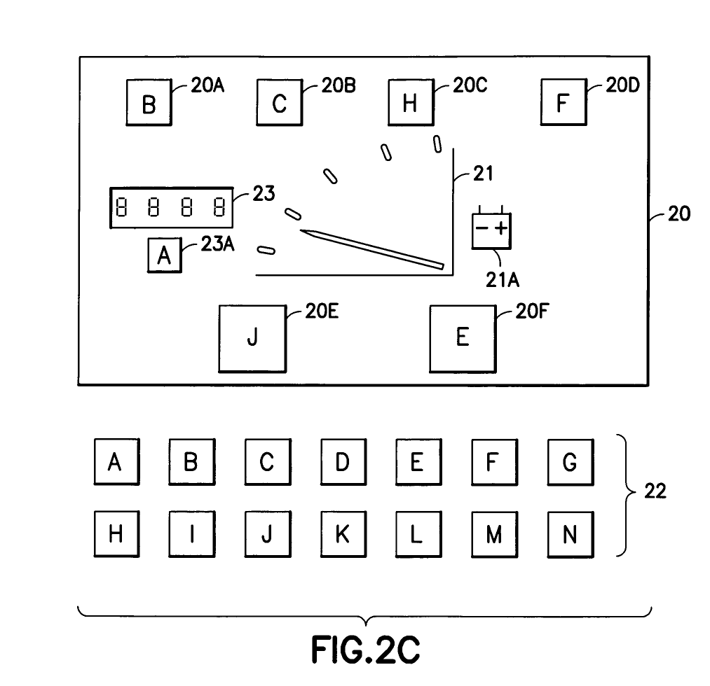

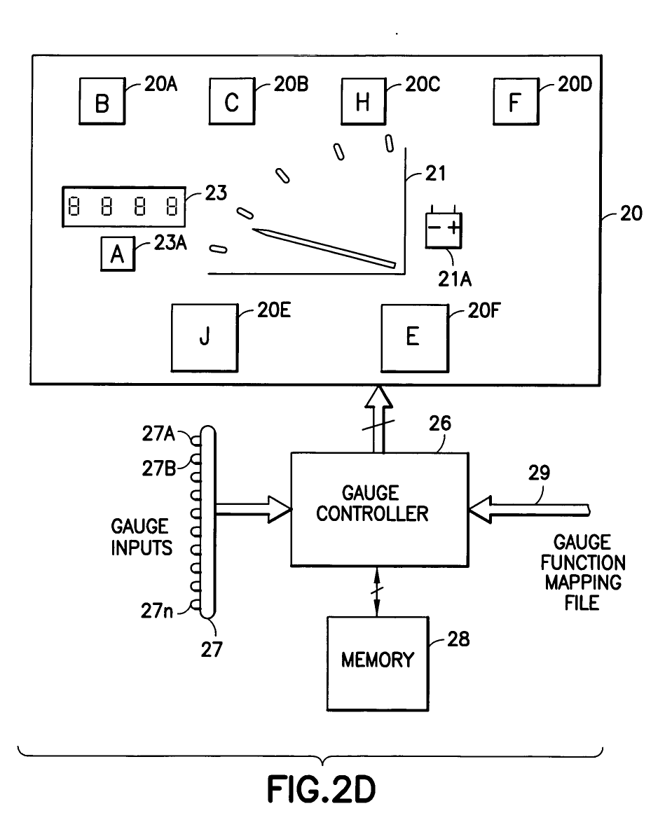

FIG. 2A is an exemplary display screen 1 showing, in accordance with a second web tool embodiment of this invention, a gauge 20 and a plurality of visual aids 22 corresponding to various configurable gauge functions 20A-20F, whereby a customer is enabled to specify various aspects of the gauge using a drag-and-drop procedure. In this non-limiting embodiment the gauge 20 includes a bar graph or similar multi-segmented indicator 21 that can be fixed in function, or that can have limited configurability, as indicated by the exemplary battery and fuel visual aids 21A and 21B. The exemplary gauge 20 also includes a multi-segment numeric display 23, and a configurable numeric display function 23A.

A non-exhaustive list of visual aids 22 include those that correspond to the following gauge indicators and functions:

Horn

Battery

Hour Meter

Fast (Rabbit)

Slow (Turtle)

Maintenance

Engine Oil—Pressure

Engine Oil—Temperature

Engine Coolant—Temperature

Glow Plug

Transmission Oil—Pressure

Transmission Oil—Temperature

Transmission—Forward 1^{st} Gear

Transmission—Forward 2^{nd} Gear

Transmission—Forward 3rd Gear

Hydraulic Oil—Pressure

Hydraulic Oil—Temperature

Park Brake

Fuel

Headlights—High Beam

Hazard

Turn Signals

PTO

PTO—Rotational Speed

FIG. 2B shows a drag and drop procedure (indicated by the arrows 24) whereby the customer selects various ones of the visual aids 22, e.g., with a mouse click, then drags the selected visual aid to a desired one of the gauge functions 20A-20F, 23A. The selected visual aid is then dropped onto the desired gauge function 20A-20F, 23A, thereafter associating the gauge function with the function represented by the visual aid (e.g., Turn Signal, Hour Meter (23A), Hazard, etc.). FIG. 2B also shows an exemplary mouse click 25 made on the battery visual aid 21A to select same to be associated with the bar graph or similar multi-segmented indicator 21.

As a result of the operations depicted in FIG. 2B, the resulting configured gauge is shown in FIG. 2C, whereby the configurable gauge functions 20A-20F, 23A have all been associated with a function defined by selected ones of the visual aids.

Note in this embodiment that the bar graph or similar indicator 21 may also have additional configurability, such as by having the ability to be associated with any type of analog visual aid function, such as any one of the above listed temperature or pressure visual aids, and not just the battery or fuel visual aids 21A, 21B as shown in FIG. 2A.

Referring now as well to FIG. 2D, as a result of configuring the gauge 20 a corresponding data file or data object representing the mapping between gauge functions 20A-20F, 23A and visual aids is formed and is sent to the appropriate manufacturer location(s), as was shown in FIG. 4 for the case of FIGS. 1A-1C. The gauge function mapping data file 29, or a processed version thereof, is subsequently loaded into the gauge 20 (block J of FIG. 4). More specifically, the gauge function mapping data file 29 is input to a gauge controller 26, such as a microprocessor, either directly or indirectly via a memory 28. The memory 28 can be separate from, or a part of, the gauge controller 26. The memory 28 can be a non-volatile memory that is loaded once at the manufacturer/distributor site, or it may be a volatile memory that is loaded from a local controller each time that equipment that the contains the gauge 20 is powered up. In either case the gauge controller 26 uses the gauge function mapping data file 29 to map between gauge inputs 27A-27n located on a gauge connector 27 and the various ones of the gauge functions 20A-20F, 23A. The end result is that the gauge controller 26 displays and activates the gauge functions 20A-20F, 23A appropriately. For example, the gauge controller 26 flashes an LED corresponding to one of the gauge functions depending on the state of a digital input at the corresponding gauge input pin 27A-27n, or changes the numeric display 23 based on a value of analog signal at the corresponding gauge input pin 27A-27n.

In a most preferred embodiment all or a portion of the gauge function mapping data file 29, or a processed version thereof, is loaded into the gauge 20 in a completely automatic manner, requiring no or minimal support by or participation of manufacturing and/or engineering personnel. In this manner the customer-specified data file derived from the web tool is automatically processed, if necessary, to make it compatible with the loadable format of the gauge function mapping data file 29, and the gauge function mapping data file 29 is then automatically loaded into one or more generic gauges corresponding to the customer-selected gauge type, thereby generating, at minimal cost, the customer gauge samples.

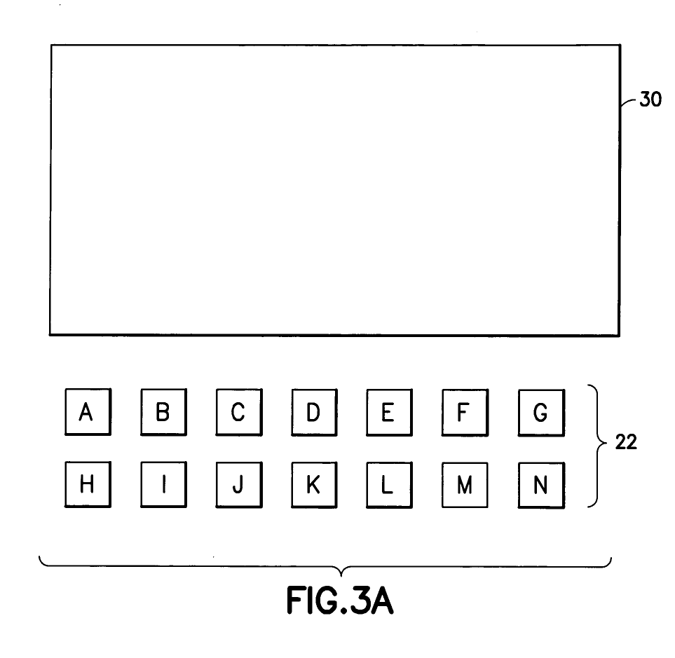

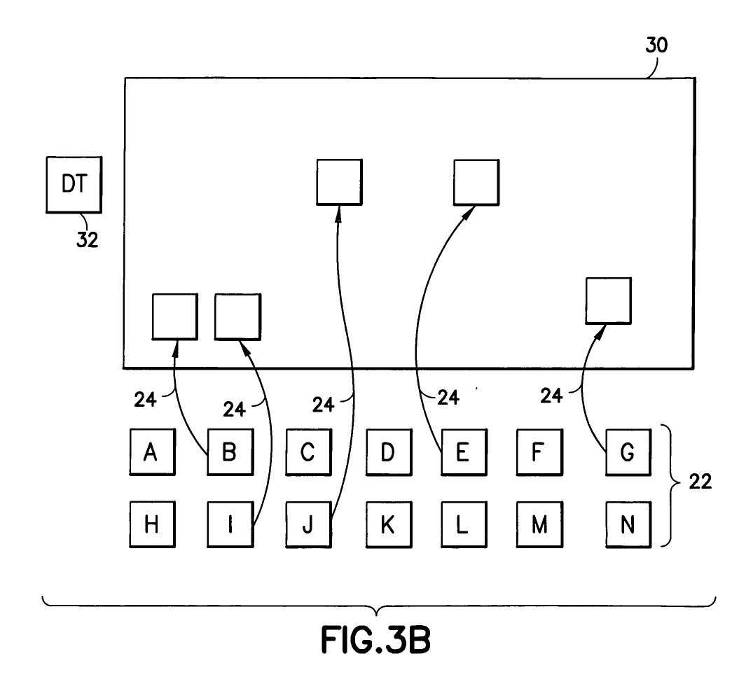

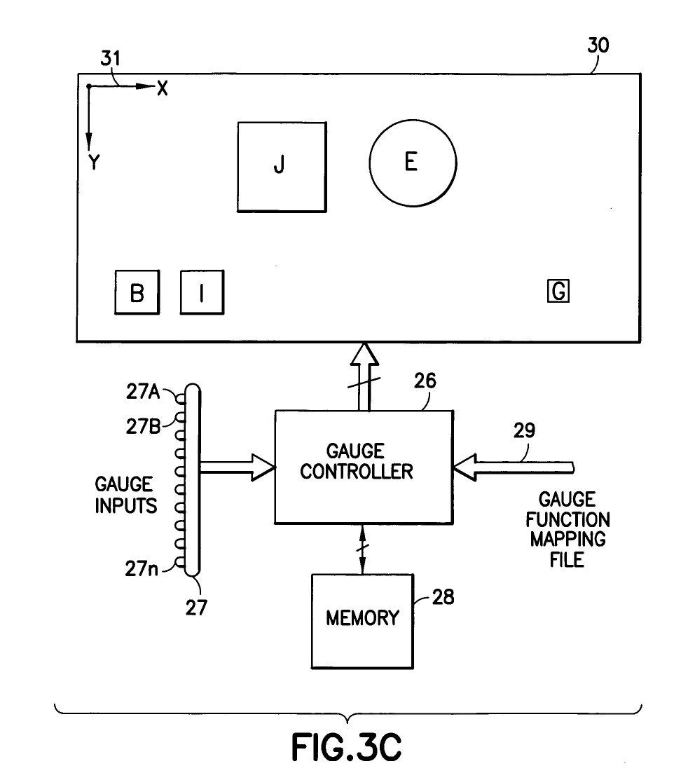

In the embodiment of FIGS. 2A-2D the various gauge functions 20A-20F, 23A, and the bar graph or similar multi-segmented indicator 21, are fixed in location and fixed in size relative to the perimeter of the gauge 20. While for many applications this is a very satisfactory solution, FIGS. 3A-3C show an embodiment that provides full customer programmability over the placement, sizes and functionality of the various gauge functions 20A-20F, 23, 23A, and possibly of the bar graph or similar multi-segmented indicator 21 as well.

In the non-limiting embodiment shown in FIG. 3A the customer is initially presented with a blank gauge face 30, or one having at least one pre-defined or fixed function (not shown), and the plurality of visual aids 22. FIG. 3B shows a drag and drop operation illustrated with the arrows 24, where the customer drags and drops selected one of the visual aids 22 to various (customer defined) locations on the blank gauge face 30. At this time the customer may also (optionally) re-size the various visual aids, change the orientation of (e.g., rotate) the various visual aids, change the aspect ratio of the various visual aids, and/or change the shape of the visual aids, using a suitable drawing tool (DT 32).

FIG. 3C shows an example of the result of the operations performed in FIG. 3B, wherein the customer specified locations, sizes and shapes of the visual aids B, I, J, E and G are incorporated into the gauge function mapping file 29. The locations (and sizes and shapes) of the individual ones of the visual aids 22 can be specified relative to some gauge coordinate system 31. For example, the locations of the four corners of a polygonal visual aid 22 can be expressed in x-y coordinates, while the circular visual aid E can be specified in the gauge function mapping file 29 by a point, given by a pair of x-y coordinates, and a radius. More complex shapes can be specified in a similar manner if desired.

In this embodiment the gauge 30 may be comprised of an LCD or a plasma or other type of display comprised of a two dimensional array of separately addressable image pixels, and the gauge controller 26 in this case configures the display at power up so as to display the desired visual aids at the customer designated locations, with the customer designated sizes and shapes.

Alternatively, the customer-specified gauge face may be translated into an overlay artwork having the desired characteristics, and the overlay is then placed over the gauge face. In this case the gauge face may overlie a plurality of LEDS or other type of indicator lights embedded in a regular two dimensional array, and the gauge controller 26 activates and deactivates only certain ones of the indicator lights based on knowledge of the geometry of the overlay pattern, the gauge coordinate system 31, and the data conveyed by the gauge function mapping file 29.

In the embodiments of FIGS. 2 and 3 the web tool that receives the customer's input is assumed to provide validity checking to prevent the customer from making inappropriate choices and selections. As but one example, an analog type of indicator, such as the indicator 21, would not be associated with a strictly binary type of gauge input, such as a directional signal or a headlamp (on/off) signal. In corresponding fashion, a strictly binary type of visual aid would normally not be associated with an analog input signal, such as voltage or pressure or temperature. For the embodiment of FIG. 3 the customer would preferably be prevented from resizing an visual aid to an inappropriate (too large or too small) size. Also, the customer would be prevented from specifying more than some predetermined number of gauge functions for a selected gauge type.

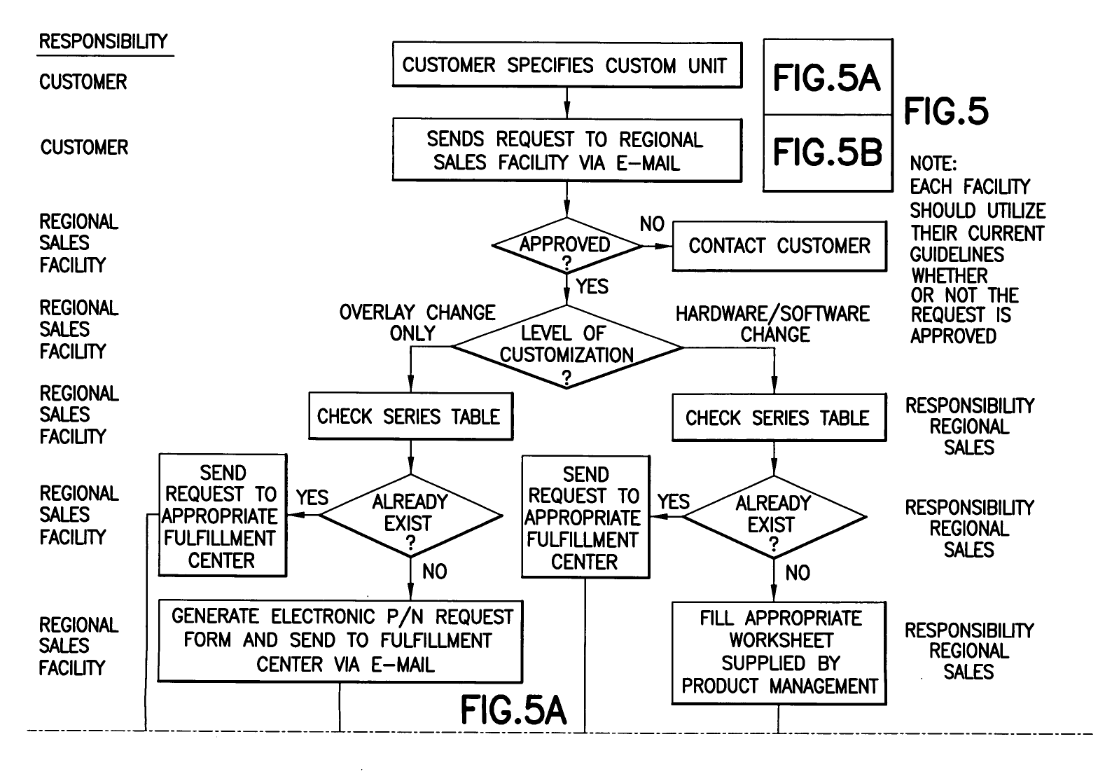

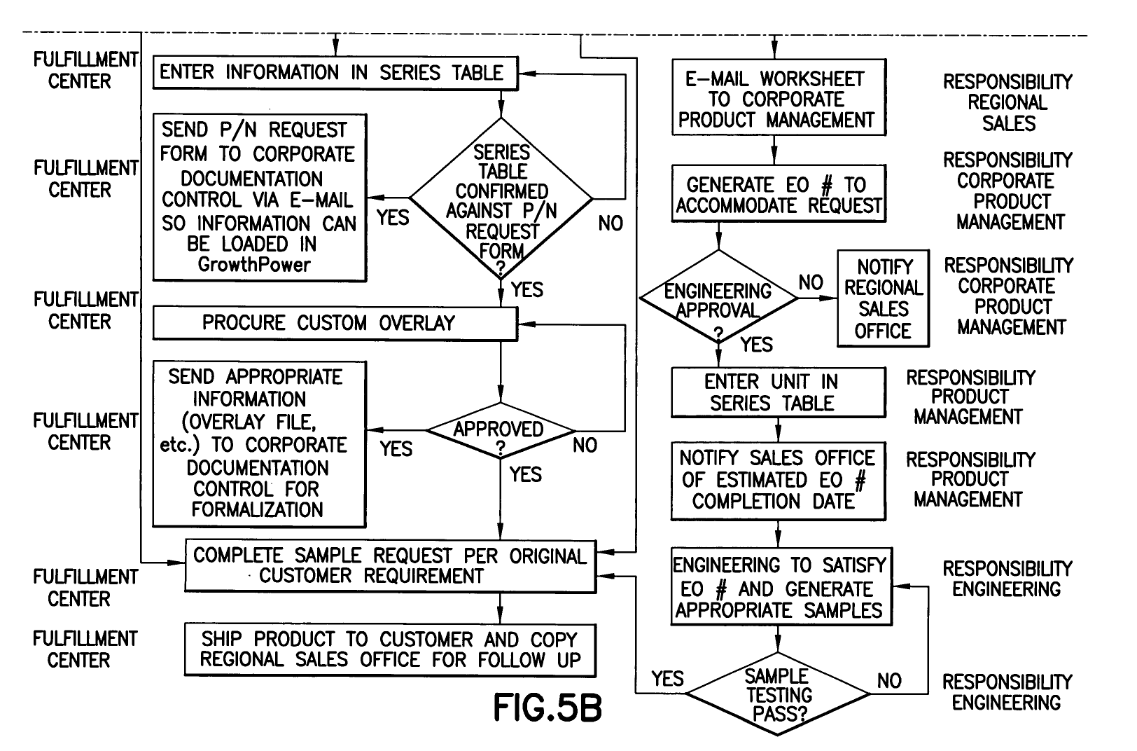

The embodiments of FIGS. 2 and 3 maybe considered as specifying custom gauges, either de novo gauges or non-standard variations of existing gauge types. In this case the flow diagram of FIG. 5 may be more appropriate as a business model for providing one or more samples to the customer. Note the possible involvement of the Engineering functions (design and test) when a hardware/software change is required by the level of customization specified by the customer.

While described in the context of various presently preferred embodiments, it should be appreciated that those skilled in the art may derive various modifications to these embodiments when guided by the foregoing description. As but one example, the teachings of this invention are not limited for use with only the specific visual aid functions listed above. Further by example, these teachings can be adapted to the specification and supply of samples of apparatus other than gauges, such as various types of scientific and medical apparatus and instruments including, but not limited to, test and measurement apparatus and instruments.

What is claimed is:

1. A method to at least specify, document and prototype an instrument having specific user interface elements to meet individual customer/market needs, comprising displaying, with a graphical user interface, an image of a customer-selected instrument type; enabling the customer to specify, with the graphical user interface, individual ones of a plurality of instrument parameters in a self-documenting fashion; in response to a selection of at least one type of instrument parameter, updating the displayed image to correspond to the selected instrument parameter; and developing at least one prototype instrument for the customer based on the selected parameters and the self-documentation.

2. A method as in claim 1, further comprising manufacturing an instrument based on the selected instrument parameters and the self-documentation.

3. A method to specify a gauge, comprising:
in response to a user accessing a server coupled to a data communications network, displaying an image of a user-selected gauge type;
specifying individual ones of gauge functions using a plurality of drop down menus; and
in response to a selection of at least one type of gauge function, changing the displayed image to correspond to the selected gauge function.

4. A method as in claim 3, further comprising preparing at least one sample of the selected gauge type in accordance with the selected gauge functions.

5. A method to specify a gauge, comprising:
in response to a user accessing a server coupled to the network, displaying an image of a user-selected gauge type;
displaying in association with the selected gauge type a set of visual aids corresponding to configurable gauge functions;
specifying individual ones of the configurable gauge functions using said set of visual aids and a drag and drop technique for selecting individual visual aids from the set of visual aids and associating a selected visual aid with a configurable gauge function; and
outputting a data file for use in preparing at least one sample of the selected gauge type in accordance with the gauge functions corresponding to the selected visual aids.

6. A method as in claim 5, where the configurable gauge functions are located at fixed locations in the image.

7. A method as in claim 5, where the configurable gauge functions are located at user selected locations in the image.

8. A method as in claim 5, where the configurable gauge functions are located at user selected locations in the image, and have a fixed size and shape.

9. A method as in claim 5, where the configurable gauge functions are located at user selected locations in the image, and have at least one of a size and a shape selected by the user.

10. A tool operable to specify a gauge, comprising a graphical user interface for displaying an image of a selected gauge type and for enabling a user of the web tool to specify individual ones of gauge functions using at least one drop down menu, further operable, in response to a selection of at least one type of gauge function, to change the displayed image to correspond to the selected gauge function.

11. A tool as in claim 10, further operable to send a data file for use in preparing at least one sample of the selected gauge type in accordance with the selected gauge functions.

12. A tool operable to enable a user to specify a gauge, comprising a graphical user interface for displaying an image of a user-selected gauge type, for displaying in association with the selected gauge type a set of visual aids corresponding to configurable gauge functions and for enabling the user to specify individual ones of the configurable gauge functions using said set of visual aids with a drag and drop technique for selecting individual visual aids from the set of visual aids and associating a selected visual aid with a configurable gauge function, said web tool being further operable for outputting a data file for use in preparing at least one sample of the selected gauge type in accordance with the gauge functions corresponding to the selected visual aids.

13. A tool as in claim 12, where the configurable gauge functions are located at fixed locations in the image.

14. A tool as in claim 12, where the configurable gauge functions are located at user selected locations in the image.

15. A tool as in claim 12, where the configurable gauge functions are located at user selected locations in the image, and have a fixed size and shape.

16. A tool as in claim 12, where the configurable gauge functions are located at customer selected locations in the image, and have at least one of a size and a shape that is selected by the user.

17. A method to conduct business over a data communications network, comprising:
in response to a user accessing a server coupled to the network, displaying an image of a user-selected gauge type;
specifying individual ones of a plurality of gauge functions using a plurality of drop down menus; and
in response to a selection of at least one type of gauge function, changing the displayed image to correspond to the selected gauge function for providing the user with an image that corresponds to the selected gauge type having the selected gauge function.

18. A method as in claim 17, further comprising preparing at least one sample of the selected gauge type, in accordance with the selected gauge functions, for delivery to the user.

19. A method as in claim 17, where the data communications network is comprised of the Internet.

20. A method to conduct business over a data communications network, comprising:
in response to a user accessing a server coupled to the network, displaying an image of a user-selected gauge type;
displaying in association with the selected gauge type a set of visual aids corresponding to configurable gauge functions;
specifying individual ones of the configurable gauge functions using said set of visual aids and a drag and drop technique for selecting individual visual aids from the set of visual aids and associating a selected visual aid with a configurable gauge function; and
outputting a data file for use in preparing at least one sample of the selected gauge type, in accordance with the gauge functions corresponding to the selected visual aids.

21. A method as in claim 20, where the data communications network is comprised of the Internet.

22. A method to design at least one user interface element of an instrument, comprising:
displaying an image of a selected instrument type;
specifying, through the use of a graphical user interface, at least one characteristic of the at least one user interface element;
in response to specifying the at least one characteristic, updating the displayed image to correspond to the specified at least one characteristic; and
developing an output data object for use in obtaining at least one prototype sample of the instrument having the specified at least one characteristic of the at least one user interface element.

23. A method as in claim 22, where specifying comprises using a drag and drop technique.

24. A method as in claim 22, where specifying comprises using a drop down menu technique.

25. A method as in claim 22, where specifying comprises using a drawing tool.

26. A method as in claim 22, where at least a portion of the data object is stored in the instrument for use by a controller in controlling operation of the at least one user interface element.

27. A method as in claim 22, where at least a portion of the data object is stored in a non-volatile memory of the instrument for use by an instrument controller in controlling operation of the at least one user interface element.

28. A method as in claim 22, where at least a portion of the data object is stored in a volatile memory of the instrument for use by an instrument controller in controlling operation of the at least one user interface element.

29. A method as in claim 22, where at least a portion of the data object is stored in the instrument for use by an instrument controller in mapping between at least one instrument input and the at least one user interface element.

30. A method as in claim 22, where specifying uses at least one tool for enabling a user to select at least a placement, a size and a functionality of the at least one user interface element.

31. A method as in claim 22, where displaying displays a blank instrument face, and where specifying uses at least one tool comprising a drawing tool for enabling a user to select at least a placement, a size and a functionality of the at least one user interface element.

32. A method as in claim 22, where the instrument comprises a display, and where the data object is loaded into the instrument for use by an instrument controller in displaying, in cooperation with the display, the at least one specified user interface element.

33. A method as in claim 22, where specifying comprises performing a validity check to ensure that the at least one characteristic that is specified is compatible with the functionality of the at least one user interface element.

34. A method as in claim 22, where specifying comprises re-sizing a displayed user interface element.

35. A method as in claim 22, where specifying comprises changing an orientation of a displayed user interface element.

36. A method as in claim 22, where specifying comprises changing a location of a displayed user interface element.

37. A method as in claim 22, where specifying comprises changing an aspect ratio of a displayed user interface element.

38. A method as in claim 22, where specifying comprises changing a shape of a displayed user interface element.

39. A method as in claim 22, where the instrument comprises a gauge.

40. A method as in claim 32, where the display comprises a two dimensional array of separately addressable pixels.

41. A method as in claim 32, where the display comprises one of a liquid crystal display and a plasma display.

42. A method as in claim 22, where the instrument comprises a plurality of indicators and an overlay placed over the indicators, the overlay having areas selectively removed, and where the data object is loaded into the instrument for use by an instrument controller in displaying, in cooperation with the plurality of indicators and the overlay, the at least one specified user interface element.

43. An instrument comprising:
a display for showing at least one user interface element;
a memory; and
an instrument controller that is coupled to said memory, to said display and to at least one instrument input, said memory storing data for use by said instrument controller in mapping between said at least one instrument input and said at least one user interface element, where
the data comprises data developed during an interactive design process where there was displayed an image of a selected instrument type for enabling a potential customer to specify, through the use of a graphical user interface, at least one characteristic of the at least one user interface element.

44. An instrument as in claim 43, where the data developed during the interactive design process is suitable for use in obtaining at least one prototype sample of the instrument having the specified at least one characteristic of the at least one user interface element.

45. An instrument as in claim 43, where the at least one user interface element comprises a gauge.
